(19) United States
(12) Patent Application Publication
(10) Pub. No.: US 2014/0258923 A1
(43) Pub. Date: Sep. 11, 2014

(54) APPARATUS AND METHOD FOR DISPLAYING SCREEN IMAGE

(71) Applicant: Samsung Electronics Co., Ltd, Gyeonggi-do (KR)

(72) Inventors: Yung-Kwan Kim, Seoul (KR); Jong-Seok Kim, Suwon-si (KR)

(73) Assignee: Samsung Electronics Co., Ltd, Gyeonggi-do (KR)

(21) Appl. No.: 14/098,138

(22) Filed: Dec. 5, 2013

(30) Foreign Application Priority Data
Mar. 8, 2013 (KR) 10-2013-0025321

(51) Int. Cl. G06F 3/0484; G06F 3/0488

(52) U.S. Cl. CPC G06F 3/04845; G06F 3/0488
USPC 715/799

(57) ABSTRACT

A user terminal includes a touch screen configured to receive a touch gesture input and display a screen image, and a control unit configured to set a touch-move determination region with reference to a touch starting point according to the touch gesture input, and when a touch-move line of the touch gesture input passes a predetermined reference region in a predetermined direction in the touch-move determination region, to move and display the screen image in the predetermined direction. The user terminal enables the movement of a screen image in a direction between vertical and horizontal directions, including vertical and horizontal movements and a diagonal movement to be more conveniently and efficiently conducted.

### CROSS-REFERENCE TO RELATED APPLICATION(S) AND CLAIM OF PRIORITY

The present application is related to and claims priority under 35 U.S.C. §119(a to Korean Application Serial No. 10-2013-0025321, which was filed in the Korean Intellectual Property Office on Mar. 8, 2013, the entire content of which is hereby incorporated by reference.

### TECHNICAL FIELD

The present disclosure relates generally to a user terminal, and, more particularly, a method of displaying a screen on a display in the user terminal.

### BACKGROUND

Recently, a mobile device such as a user terminal, for example, a portable phone, a smart phone or a tablet PC is provided with at least one display, and provides a function of displaying screens corresponding to various contents such as a photograph, an moving image, an application and a web page using the display.

However, the number, sizes or the like of physical displays of a user terminal is limited in view of the portability but the number, sizes or the like of screen image desired to be displayed becomes diversified. Thus, various methods for displaying a screen image efficiently on a limited display have been developed.

For example, a recent user terminal displays a screen image displayed on the display in a state where the screen image is moved in each direction including up, down, left, right and diagonal directions according to a user's movement request input in each direction including up, down, left, right and diagonal directions. For this purpose, the user terminal determines a direction to move the screen image using the touch gesture input by the user.

However, a user terminal that determines the screen movement based on an angle according to a touch gesture input has a limit in that the user should input a touch gesture within a predetermined angle with reference to a vertical or horizontal direction in order to move the screen image. In addition, when the touch gesture is erroneously input beyond the predetermined angle although the user desires a vertical or horizontal direction, the screen image may be moved in an undesired diagonal direction. Thus, there is a problem in that inconvenience may be caused when the user moves a screen image on a display.

### SUMMARY

To address the above-discussed deficiencies of the prior art, it is a primary object to provide a user terminal and a method of displaying a screen on the user terminal which allow a user to conveniently conduct an input for screen movement even if the user does not correctly conduct a vertical or horizontal input.

Another aspect of the present disclosure is to provide a user terminal and a method of displaying a screen on the user terminal which allow a screen image to be moved more conveniently and efficiently than the prior art.

According to an aspect of the present disclosure, there is provided a user terminal including a touch screen configured to receive a touch gesture input and display a screen image, and a control unit configured to set a touch-move determination region with reference to a touch starting point according to the touch gesture input, and when a touch-move line of the touch gesture input passes a predetermined reference region in a predetermined direction in the touch-move determination region, to move and display the screen image in the predetermined direction.

According to another aspect of the present disclosure, there is provided a method of displaying a screen on a user terminal. The method includes setting a touch starting point according to a touch gesture input, setting a touch-move determination region with reference to the touch starting point, and determining whether or not a touch-move line of the touch gesture input passes a predetermined reference region in a predetermined direction in the touch-move determination region, and moving and displaying the screen image in the predetermined direction when the touch-move line of the touch gesture input passes the predetermined reference region in a predetermined direction.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and B are conceptual views for describing screen moving direction determination in an ordinary user terminal;

FIG. 2 is a schematic block diagram illustrating a user terminal according to an exemplary embodiment of the present disclosure;

FIG. 3 is a front side perspective view of a user terminal according to embodiments of the present disclosure;

FIG. 4 is a conceptual view for describing a touch starting point and a touch-move determination region according to embodiments of the present disclosure;

FIG. 5 is a flowchart illustrating a method of displaying a screen image movement on a user terminal according to the first embodiment of the present disclosure;

FIG. 6 is a view illustrating a case where a touch-move line exists within a central region on the touch-move determination region according to embodiments of the present disclosure;

FIG. 7 is a view illustrating a case where the touch-move line passes any one of predetermined reference regions on the touch-move determination region according to embodiments of the present disclosure;

FIG. 8 is a view illustrating a case where a Y-axis vector value of the touch-move line is larger than an X-axis vector value according to embodiments of the present disclosure;

FIG. 9 is a view illustrating a case where an X-axis vector value of the touch-move line is larger than a Y-axis vector value according to embodiments of the present disclosure;

FIG. 10 is a view illustrating a case where a Y-axis vector value of the touch-move line and an X-axis vector value are equal to each other according to embodiments of the present disclosure;

FIG. 11 is a flowchart illustrating a method of displaying a screen image movement on a user terminal according to the second embodiment of the present disclosure;

FIG. 12 is a flowchart illustrating a method of displaying a screen image movement on a user terminal according to the third embodiment of the present disclosure;

FIG. 13 is a flowchart illustrating a method of setting a touch starting point according to the first embodiment of the present disclosure; and

FIG. 14 is a flowchart illustrating a method of setting a touch starting point according to the second embodiment of the present disclosure.

### DETAILED DESCRIPTION

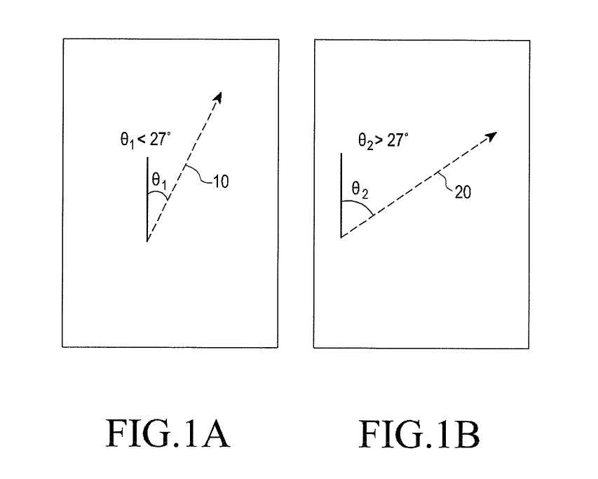

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Terms used herein will be briefly explained and then the present disclosure will be described in detail.

The terms used herein have been selected in consideration of functions in the present disclosure and among the terms which are most widely used at present. However, the terms may be changed according to an intention of a technician who works in this field, a precedent, an appearance of a new technology or the like. In addition, at a certain case, a term arbitrarily selected by the applicant may be used. In such a case, the meaning of the term will be described in detail at the corresponding part in the description of the present disclosure. Thus, a term used herein should be defined based on the meaning of the term and the entire contents of the present disclosure rather than merely on the name expressed by the term.

In the entire specification of the present application, when it is described that a certain unit “includes” a certain element, this means that the unit may include any other element rather than exclude the any other element unless otherwise described. In addition, the term, “xxx unit,” or the like used herein means a unit that processes at least one function or operation and may be implemented by a combination of hardware and software.

The expression, “touch gesture input,” used herein means an input by a touch gesture conducted by the user in order to control the user terminal. For example, the touch gesture input used herein may include “touch-on,” “touch-move,” “touch-off” or the like.

The “touch-on” indicates a user's operation of touching a screen and maintaining the touch using a part of body such as a finger or a touch instrument (a stylus pen or any other instrument that enables a screen movement). That is, it means a status from touch-in time which is a point of time when a finger or a touch instrument touches the screen to touch-out time which is a point of time when the finger or the touch instrument is removed from the screen.

The term, “touch-move,” means an operation of, after the user touches the screen using a body such as a finger or a touch instrument (a stylus pen or any other instrument that enables a screen movement), moving the finger or the touch instrument to another position within the screen in a state where the touch is maintained.

The term, “touch-off,” means a state in which the user removes the finger or the touch instrument from the screen in the state in which the user's finger or the touch instrument touches the screen.

Hereinafter, embodiments according to the present disclosure will be described in detail with reference to accompanying drawings. However, the present disclosure is not restricted or limited by the embodiments. The same reference numeral represented in each of the drawings indicates elements that conduct substantially the same functions.

FIGS. 1A and 1B illustrate a screen moving direction determination in a user terminal. Referring to FIG. 1, the screen image moving direction is determined based on the angle between a predetermined reference (vertical direction) and a user's touch gesture input (e.g., 27 degrees). For example, when the angle between the predetermined reference (vertical direction) and the user's touch gesture input does not exceed 27 degrees as in FIG. 1a, the screen image moving direction is determined as the vertical direction, and when the angle between the predetermined reference (vertical direction) and the user's touch gesture input exceeds 27 degrees as in FIG. 1b, the screen image moving direction is determined as the direction of the user's touch gesture input 20.

However, since this method makes a determination using an angle, there is a limit in that the user should input a touch gesture within a predetermined angle with reference to a vertical or horizontal direction in order to move the screen image. In addition, when the touch gesture is erroneously input beyond the predetermined angle although the user desires a vertical or horizontal direction, the screen image may be moved in an undesired diagonal direction. Thus, inconvenience may be caused when the user moves a screen. Accordingly, in the various embodiments of the present disclosure, it is intended to provide a user terminal and a method of displaying a screen on the user terminal which allow a user to conveniently conduct an input for screen movement even if the user does not correctly conduct a vertical or horizontal input.

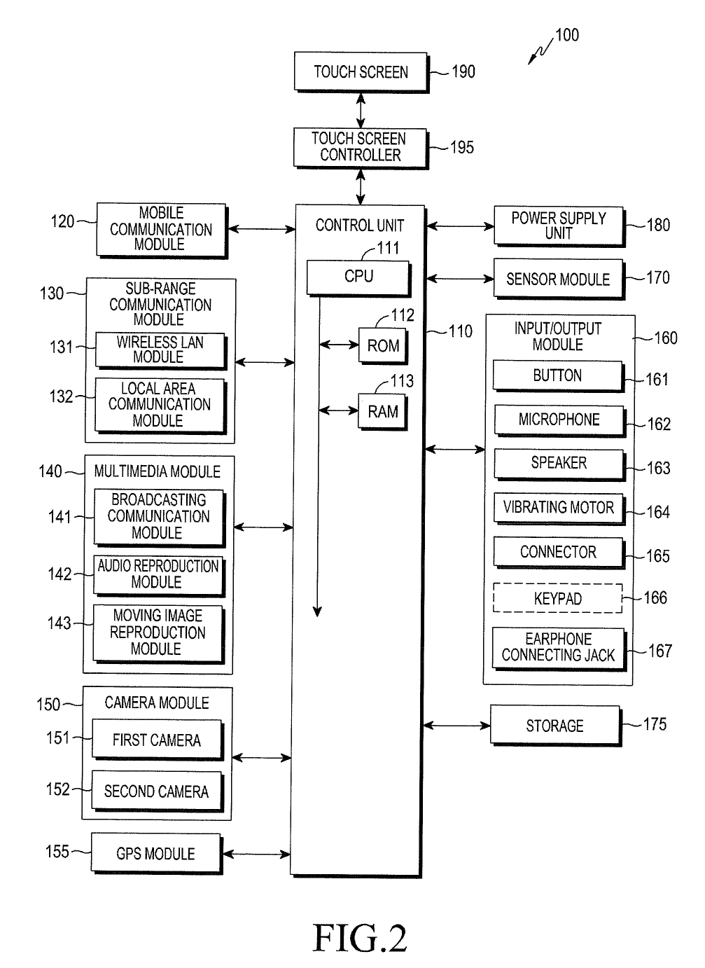

FIG. 2 is a schematic block diagram illustrating a user terminal according to embodiments of the present disclosure. Referring to FIG. 2, the user terminal 100 (herein below, also referred to as an “apparatus”) can be connected with an external apparatus (not illustrated) using a mobile communication module 120, a sub-communication module 130, and a connector 165. The “external apparatus” can include another apparatus (not illustrated), a portable phone (not illustrated), a smart phone (not illustrated), a tablet PC (not illustrated), and a server (not illustrated).

Referring to FIG. 2, the user terminal 100 includes a touch screen 190 and a touch screen controller 195. In addition, the user terminal 100 includes a control unit 110, a mobile communication module 120, a sub-communication module 130, a multimedia module 140, a camera module 150, a GPS module 155, an input/output module 160, a sensor module 170, and a power supply unit 180. The sub-communication module 130 includes at least one of a wireless LAN module 131 and a local area communication module 132, and the multimedia module 140 includes at least one of a broadcasting communication module 141, an audio reproducing module 142, and a moving image reproducing module 143. The camera module 150 includes at least one of a first camera 151 and a second camera 152, and the input/output module 160 includes at least one of a button 161, a microphone 162, a speaker 163, a vibration motor 164, a connector 165, and a keypad 166.

The control unit 110 can include a CPU 111, a ROM 112 which stores control programs for controlling the user terminal 100, and a RAM 113 which stores signals or data input from the outside of the user terminal 100 or is used as a memory region for an operation executed in the user terminal 100. The CPU 111 can include a single core, dual cores, triple cores, or quad cores. The CPU 111, the ROM 112 and the RAM 113 can be connected with each other through internal buses.

The control unit 110 can control the mobile communication module 120, the sub-communication module 130, the multimedia module 140, the camera module 150, the GPS module 155, the input/output module 160, the sensor module 170, the power supply unit 180, the storage unit 185, the touch screen 190, and the touch screen controller 195.

The control unit 110 sets a touch starting point according to a user's touch gesture input, sets a touch-move determination region based on the touch starting point, and determines whether or not a touch-move line of the touch gesture input passes a predetermined reference region in a predetermined direction in the touch-move determination region. When it is determined that the touch-move line passes the predetermined reference region, the control unit conducts a control such that a screen image is moved in the predetermined direction and displayed on the touch screen.

The mobile communication module 120 allows the user terminal 100 to be connected with the external apparatus through mobile communication using one or more antennas (not illustrated) according to the control of the control unit 110. The mobile communication module 120 can transmit/receive a wireless signal for voice communication, image communication, text message (SMS), or multimedia message (MMS) and a wireless image data according to embodiments of the present disclosure to/from a portable phone (not illustrated) of which the phone number is input to the user terminal 100, a smart phone (not illustrated), a tablet PC, or other apparatuses (not illustrated).

The sub-communication module 130 can include at least one of the wireless LAN module 131 and the local area communication module 132. For example, the sub-communication module 130 can include only the wireless LAN module 131, only the local area communication module 132, or both the wireless LAN module 131 and the local area communication module 132.

The wireless LAN module 131 can be connected to the Internet according to the control of the control unit 110 in a place where a wireless AP (Access Point) (not illustrated) is installed. The wireless LAN module 131 supports the wireless LAN standard (IEEE802.11x) of the Institute of Electrical and Electronic Engineers (IEEE). The local area communication module 132 can perform local area communication wirelessly between the user terminal 100 and an image forming apparatus (not illustrated) according to the control of the control unit 110. The local area communication method can include, for example, Bluetooth and IrDA (Infrared Data Association) communication.

According to the performance, the user terminal 100 can include at least one of the mobile communication module 120, the wireless LAN module 131, and the local area communication module 132. For example, according to the performance, the user terminal 100 can include a combination of the mobile communication module 120, the wireless LAN module 131, and the local area communication module 132.

The multimedia module 140 can include the broadcasting communication module 141, the audio reproducing module 142, or the moving image reproducing module 143. The broadcasting communication module 141 can receive a broadcasting signal (e.g., a TV broadcasting signal, a radio broadcasting signal or a data broadcasting signal) which is transmitted from a broadcasting station or broadcasting added information (e.g., EPG (Electric Program Guide) or ESG (Electric Service Guide) through a broadcasting communication antenna (not illustrated) according to the control of the control unit 110. The audio reproducing module 142 can reproduce a stored or received digital audio file (e.g., a file of which the file extension is mp3, wma, ogg, or way) according to the control of the control unit 110. The moving image reproducing module 143 can reproduce a stored or received digital moving image file (e.g., a file of which the file extension is mpeg, mpg, mp4, avi, mov, or mkv) according to the control of the control unit 110. The moving image reproducing module 143 can reproduce a digital audio file.

The multimedia module 140 can include the broadcasting communication module 141, the audio reproducing module 142 and the moving image reproducing module 143. Also, the audio reproducing module 142 or the moving image reproducing module 143 of the multimedia module 140 can be included in the control unit 110.

The camera module 150 can include at least one of the first camera 151 and the second camera 152 each of which photographs a still image or a moving image according to the control of the control unit 110. In addition, the first camera 151 or the second camera 152 can include an auxiliary light source (e.g. a flash (not illustrated)) that provides an amount of light required for photographing. The first camera 151 can be disposed on the front surface of the user terminal 100 and the second camera 152 can be disposed on the rear surface of the user terminal 100.

The GPS module 155 can receive radio waves from a plurality of Earth-orbiting GPS satellites (not illustrated), and can calculate the position of the user terminal 100 using the time of arrival of the radio waves to the user terminal 100 from the GPS satellites.

The input/output module 160 can include at least one of a plurality of buttons 161, a microphone 162, a speaker 163, a vibration motor 164, a connector 165, and a keypad 166.

The buttons 161 can be formed on the front surface, side surfaces or rear surface of the housing of the user terminal 100 and can include at least one of a power/lock button (not illustrated), a volume button (not illustrated), a menu button, a home button, a back button, and a search button 161.

The microphone 162 receives an input of voice or sound to produce an electrical signal according to the control of the control unit 110.

The speaker 163 can output sounds which respectively correspond to various signals of the mobile communication module 120, the sub-communication module 130, the multimedia module 140, and the camera module 150 (e.g., a radio signal, a broadcasting signal, a digital audio file, a digital moving image file, or photographing) to the outside of the user terminal 100 according to the control of the control unit 110. The speaker 163 can output a sound which corresponds to the functions performed by the user terminal 100 (for example, a button operation sound corresponding to a phone call or a call connection sound). One or more speakers 163 can be formed at a proper position or positions of the housing of the user terminal 100.

The vibration motor 164 can convert an electronic signal to mechanical vibration according to the control of the control unit 110. For example, when the user terminal 100 set to a vibration mode receives a voice call from any other apparatus (not illustrated), the vibration motor 164 is operated. One or more vibration motors 164 can be provided in the housing of the user terminal 100. The vibration motor 164 can be operated in response to a user's touch action that touches the touch screen 190 and a continuous touch movement on the touch screen 190.

The connector 165 can be used as an interface which interconnects the user terminal 100 and an external apparatus (not illustrated) or a power source (not illustrated). The user terminal 100 can transmit data stored in the storage unit 175 of the user terminal 100 to the external apparatus (not illustrated) or receive data from the external apparatus (not illustrated) through a wired cable connected to the connector 165 according to the control of the control unit 110. The user terminal 100 can receive power from a power source (not illustrated) through the wired cable connected to the connector 165 or charge a battery (not illustrated using the power source).

The keypad 166 can receive a key input from the user so as to control the user terminal 100. The keypad 166 includes a physical keypad (not illustrated) formed on the user terminal 100 or a virtual keypad (not illustrated) displayed on the touch screen 190. The physical keypad (not illustrated) formed on the user terminal 100 can be omitted according to the performance or configuration of the user terminal 100.

The sensor module 170 includes at least one sensor that detects the status of the user terminal 100. For example, the sensor module 170 can include a proximity sensor 174 that detects whether the user approaches to the user terminal 100 or not, an illumination sensor (not illustrated) that detects the amount of light around the user terminal 100, or a motion sensor (not illustrated) that detects the operation of the user terminal 100 (e.g., rotation of the user terminal 100, or acceleration or vibration applied to the user terminal 100). At least one sensor can detect a status including the orientation and inclination of the user terminal 100, and produce a signal corresponding to the detection and transmit the signal to the control unit 110. The sensors of the sensor module 170 can be added or omitted according to the performance of the user terminal 100.

The power supply unit 180 can supply power to one or more batteries (not illustrated) disposed within the housing of the user terminal according to the control of the control unit 110. The one or more batteries (not illustrated) supply power to the user terminal 100. In addition, the power supply unit 180 can supply the power input from the external power source (not illustrated) through a wired cable connected with the connector 165.

The storage unit 175 can store signals or data input/output in response to the operations of the mobile communication module 120, the sub-communication module 130, the multimedia module 140, the camera module 150, the GPS module 155, the input/output module 160, the sensor module 170, and the touch screen 190 according to the control of the control unit 110. The storage unit 175 can store control programs and applications for controlling the user terminal 100 or the control unit 110.

The term, “storage unit” can include the storage unit 175, the ROM 112 and the RAM 113 in the control unit 110, or a memory card (not illustrated) (e.g., an SD card or a memory stick) mounted in the user terminal 100. The storage unit can include a non-volatile memory, a volatile memory, an HDD (Hard Disc Drive) or an SSD (Solid State Drive).

The touch screen 190 can provide a plurality of user interfaces that correspond to various services (e.g., phone call, data transmission, broadcasting and photographing), respectively, to the user. The touch screen 190 can transmit an analogue signal corresponding to at least one touch input to the user interfaces to the touch screen controller 195. The touch screen 190 can receive at least one touch gesture input through the user's body (e.g., fingers including a thumb) or a touchable input means, for example, an electronic pen (e.g., a stylus pen). In addition, the touch screen 190 can receive an input of continuous movement of a touch among one or more touch gestures. The touch screen 190 can transmit an analogue signal corresponding to the continuous movement of the touch input thereto to the touch screen controller 195.

In the present disclosure, the touch is not limited to a contact between the touch screen 190 and the user's body or a touchable input means and can include a contactless touch. The space detectable from the touch screen 190 can be changed according to the performance or configuration of the user terminal 100. The touch screen 190 can be implemented, for example, in a resistive type, a capacitive type, an infrared type, or an acoustic wave type or by combining two or more types.

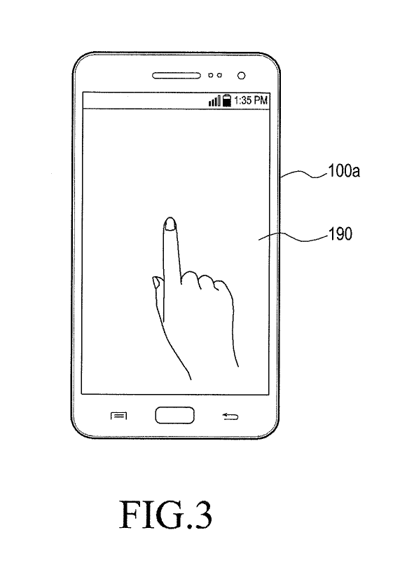

Herein below, the external configuration of the user terminal 100 will be described. FIG. 3 is a front side perspective view of the user terminal 100 according to embodiments of the present disclosure.

Referring to FIG. 3, a touch screen 190 can be disposed on a front surface 100a of the user terminal 100. The touch screen 190 can be formed to occupy almost all the front surface 100a of the mobile apparatus 100. Screens corresponding to various contents can be displayed on the touch screen 190. According to embodiments of the present disclosure, various screen image such as an application screen, a web browser screen, a photo screen, and a moving image screen can be displayed. The user can conduct at least one gesture on the touch screen 190 through a finger or a touchable input means such as a stylus pen, for example, an electronic pen (stylus pen), and the touch screen 190 can sense the touch gesture.

According to embodiments, when the user touches the touch screen 190 in the state where a screen image is displayed on the touch screen 190, the user terminal 100 configured as described above sets a touch starting point. In addition, the user terminal 100 sets a touch-move determination region with reference to the touch starting point, and determines the moving direction of the screen image using the coordinate values in the touch-move determination region.

At this time, the screen image is a screen corresponding to various contents and can be any one of various screens such as an application screen, a web browser screen, a moving image screen, and a photo screen.

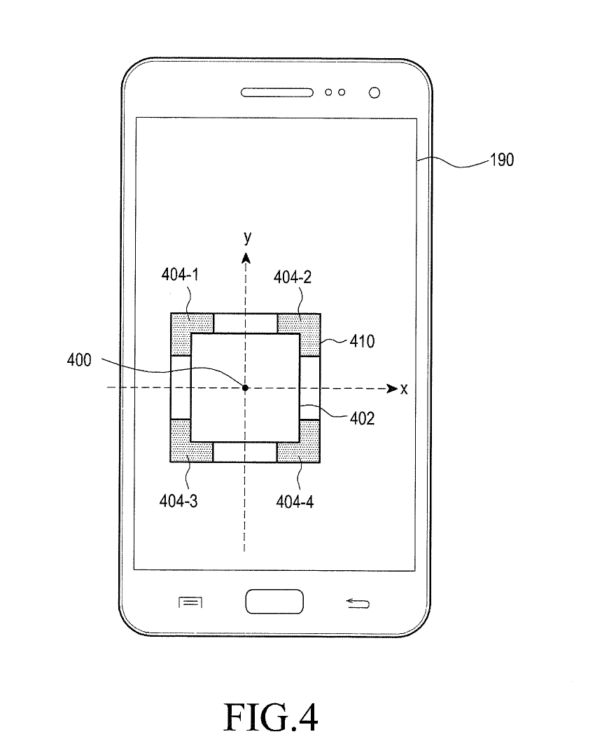

FIG. 4 is a conceptual view for describing a touch starting point and a touch-move determination region according to embodiments of the present disclosure. Referring to FIG. 4, when a user's finger or a touch input object such as a stylus pen touches on the touch screen 190, the user terminal can set the touch-on point as a touch starting point 400 and set a predetermined region as a touch-move determination region 410 with reference to the touch starting point. At this time, the size, range or shape of the touch-move determination region 410 can be adjusted by a developer of the user terminal 100 or a user who uses the user terminal 100. The touch-move determination region 410 can include a central region 402 which is a central portion of a predetermined size and a plurality of reference regions according to predetermined directions with reference to the touch starting point 400. At this time, the predetermined directions are directions between the vertical (Y-axis) direction and the horizontal (X-axis) direction, and can include a diagonal direction with reference to the vertical axis and the horizontal axis. In particular, according to an exemplary embodiment, the touch-move determination region 410 can include first to fourth reference regions 404-1 to 404-4 which respectively correspond to first to fourth directions predetermined with reference to the touch starting point 400. At this time, the size and shape of the reference regions 404-1 to 404-4 can be variously determined according to the type of the screen image or the touch screen 190 of the user terminal 100. In addition, the touch-move determination region 410 is a region which is internally processed rather than displayed on the touch screen 190. That is, although the touch-move determination region 410 is not represented to the user, the user terminal 100 can sense at which portion a touch occurs in the touch-move determination region 410.

According to embodiments of the present disclosure, when the central region 402 exists with reference to the touch starting point, the user terminal 100 maintains the status of the screen image which is being displayed and when the touch-move passes any one of the predetermined reference regions 404-1 to 404-4, the user terminal 100 moves and displays the screen image according to the touch-move.

Herein below, the method of moving and displaying the screen image according to an exemplary embodiment of the present disclosure will be described in more detail.

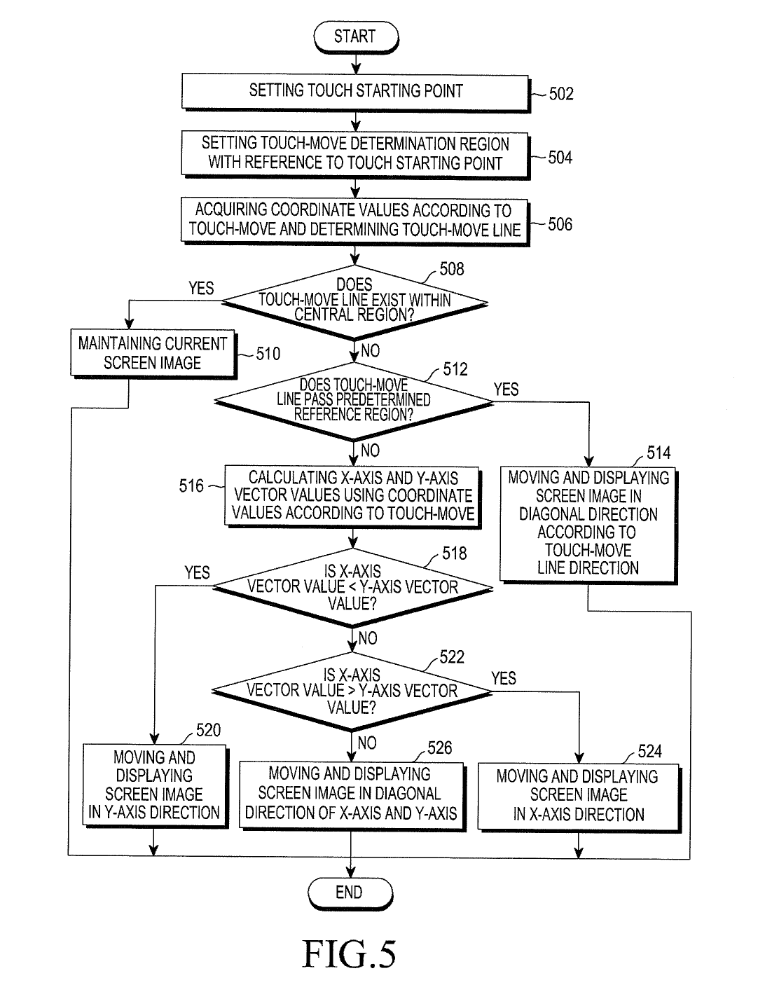

Firstly, FIG. 5 is a flowchart illustrating a method of moving and displaying the screen image according to the first embodiment of the present disclosure. Referring to FIG. 5, the user terminal 100 sets a touch starting point 400 at step 502. When the user's finger or a touch input object such as a stylus pen touches on the touch screen 190, the user terminal 100 can set the touch-on point on the touch screen 190 as the touch starting point 400. At this time, the touch starting point 400 can be set again when touch-off occurs or the touch is interrupted after touch-move. The specific procedure of such a touch starting point setting method will be described later after describing the method of moving and displaying the screen image.

When the touch starting point 400 is set, the user terminal 100 sets the touch-move determination region 410 with reference to the touch starting point at step 504. At this time, as illustrated in FIG. 4, the touch-move determination region 410 can be set as a region predetermined with reference to the touch starting point. The touch-move determination region 410 can include a central region 402 which is a central region of a size predetermined with reference to the touch starting point 400 and four reference regions 404-1 to 404-4 according to directions predetermined with reference to the touch starting point 400.

After setting the touch-move determination region 410, the user terminal 100 acquires coordinate values to determine a touch-move line at step 506. For example, when a movement is performed from a user's touch-on point to an optional area in the touch-on state (for example, drag is performed), the user terminal 100 determines a touch-move line according to the touch-move.

At step 508, the user terminal 100 determines whether or not the touch-move line exists within the central region 402 on the touch-move determination region 410.

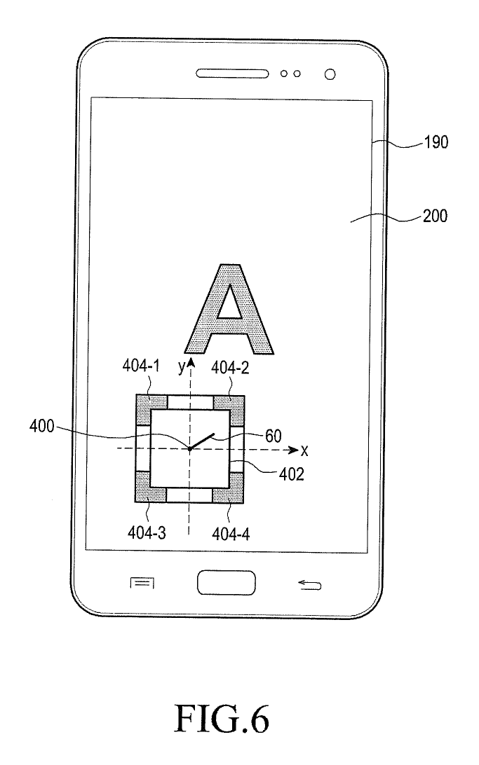

FIG. 6 illustrates a case where the touch-move line exists within the central region 402 on the touch-move determination region 410. Referring to FIG. 6, when the touch-move line 60 exists within the central region 402, the user terminal 100 proceeds to step 510 and continuously displays the screen image 200 which is being displayed, without moving the screen image.

At step 512, the user terminal 100 determines whether or not the touch-move line passes a predetermined reference region on the touch-move determination region 410. That is, the user terminal 100 determines whether or not the touch-move line passes any one of the predetermined reference regions 404-1 to 404-4 on the touch-move determination region 410.

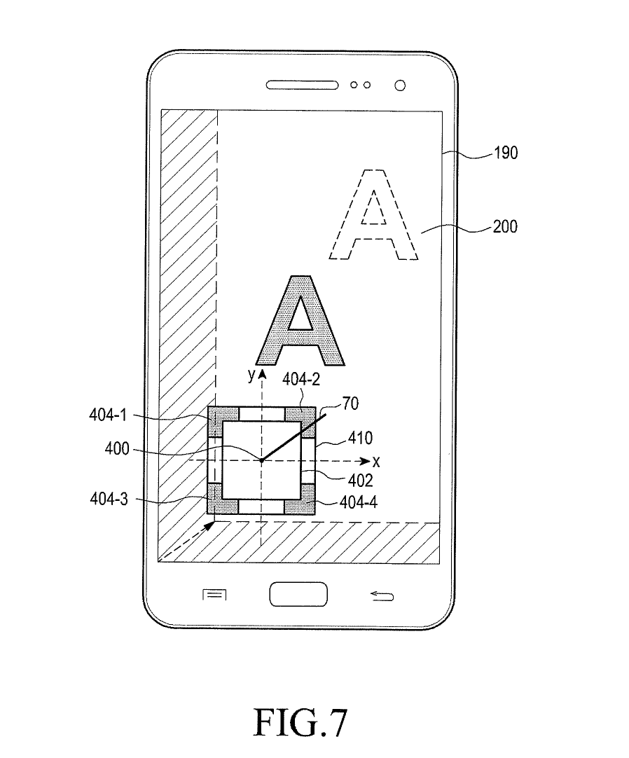

FIG. 7 illustrates a case where the touch-move line passes any one of the predetermined reference regions 404-1 to 404-4 on the touch-move determination region 410 according to the embodiment. Referring to FIG. 7, when the touch-move line 70 passes the second reference region 404-2, the user terminal 100 proceeds to step 514 and moves and displays the screen image 200 in the diagonal direction according to the touch-move line direction.

When the touch-move line does not pass any one of reference regions on the touch-move determination region, the user terminal 100 calculates X-axis and Y-axis vector values using the coordinate values according to the touch-move at step 516. Here, the X-axis vector value is a value indicating how far the touch-move has moved in the X-axis direction, and the Y-axis vector value is a value indicating how far the touch-move has moved in the Y-axis direction.

At step 518, the user terminal 100 determines whether the Y-axis vector value is larger than the X-axis vector value. When the Y-axis vector value is larger than the X-axis vector value, at step 520, the user terminal 100 moves and displays the screen image in the Y-axis direction (vertical direction).

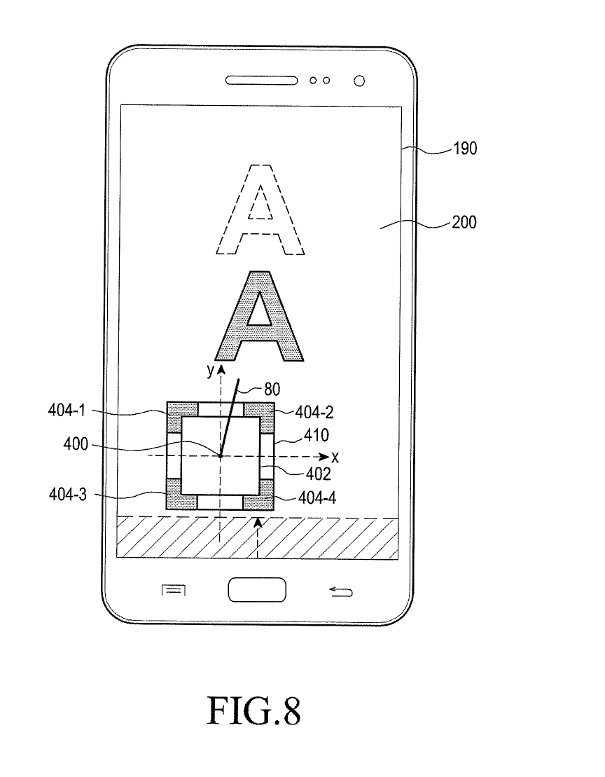

FIG. 8 illustrates a case where the Y-axis vector value of touch-move line is larger than the X-axis vector value according to embodiments of the present disclosure. Referring to FIG. 8, it is illustrated that in the user terminal 100, the Y-axis vector value of touch-move line 80 is larger than the X-axis vector value. In such a case, the user terminal 100 moves and displays the screen image 200 in the Y-axis direction.

At step 522, the user terminal 100 determines whether or not the X-axis vector value is larger than the Y-axis vector value. When the X-axis vector value is larger than the Y-axis vector value, at step 524, the user terminal 100 moves and displays the screen image 200 in the X-axis direction.

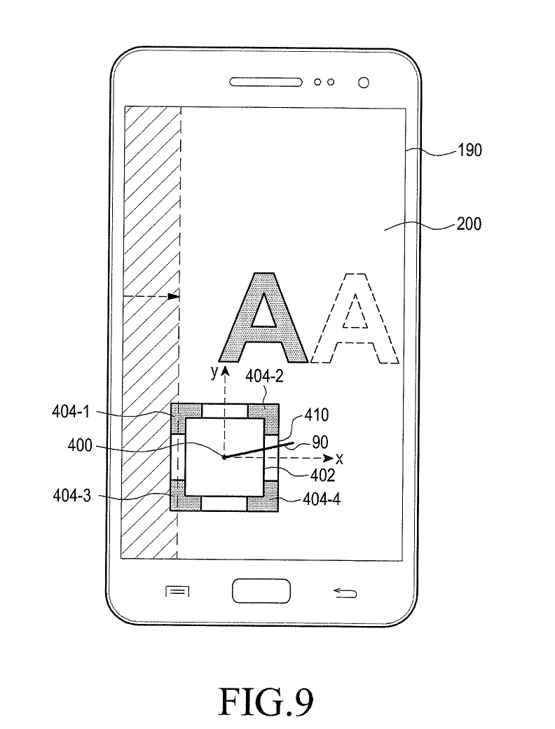

FIG. 9 illustrates a case where the X-axis vector value of touch-move line is larger than the Y-axis vector value according to embodiments of the present disclosure. Referring to FIG. 9, it is illustrated that in the user terminal 100, the X-axis vector value of touch-move line 80 is larger than the Y-axis vector value. In such a case, the user terminal 100 moves and displays the screen image 200 in the X-axis direction.

Meanwhile, when the X-axis vector value is not larger than the Y-axis vector value and the Y-axis vector value is not larger than X-axis vector value, the user terminal 100 moves and displays the screen image 200 in the diagonal direction of the X-axis and the Y-axis at step 526 because the X-axis vector value and the Y-axis vector value are equal to each other.

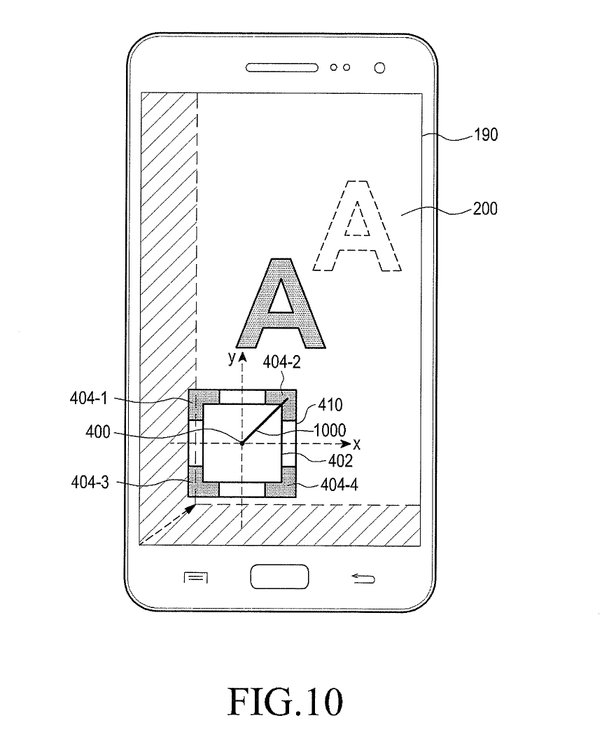

FIG. 10 illustrates a case where the X-axis vector value and the Y-axis vector value of the touch-move line are equal to each other. Referring to FIG. 10, when the X-axis vector value of the touch-move line 1000 is equal to the Y-axis vector value, the user terminal 100 moves and displays the screen image 200 in the diagonal direction of the X-axis and the Y-axis.

Meanwhile, in the first embodiment of the present disclosure, descriptions have been made above on a case where the screen image 200 is moved and displayed according to the user's touch and touch-move. However, according to the second and third embodiments, the screen image 200 can be moved and displayed not only according to the user's touch and touch-move but also according to a touch pressure.

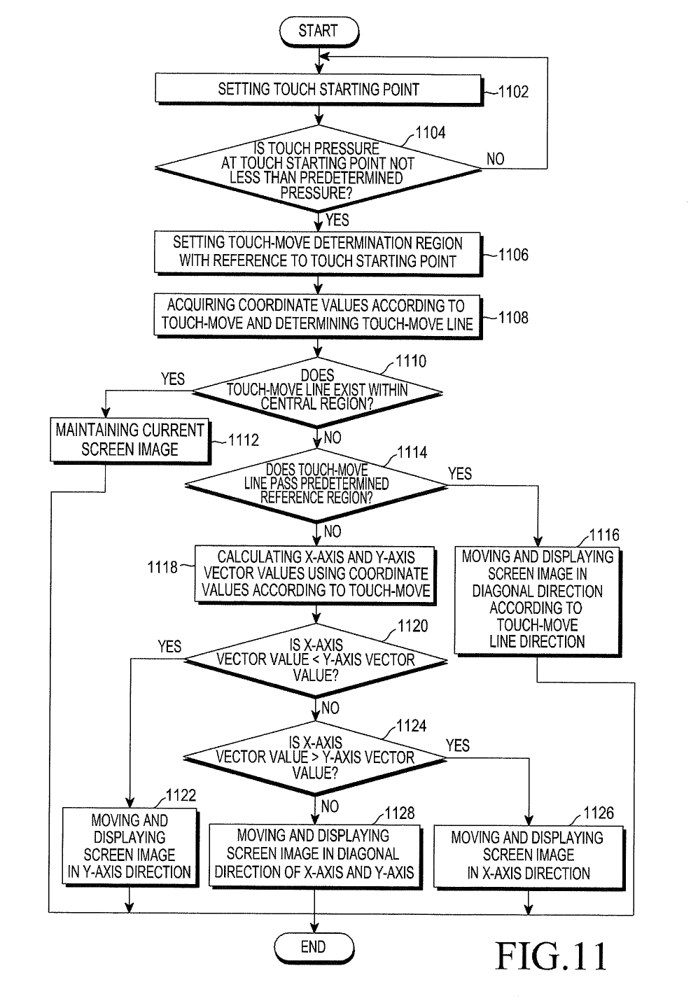

First, FIG. 11 is a flowchart illustrating a method of moving and displaying a screen image on the user terminal according to the second embodiment of the present disclosure. Referring to FIG. 11, at step 1102, the user terminal 100 sets a touch starting point. When the user's finger or a touch input object such as a stylus pen touches on the touch screen 190, the user terminal 100 can set the touch-on point as the touch starting point 400. At this time, when a touch-off occurs or the touch is stopped after the touch-move, the touch starting point 400 can be set again.

When the touch starting point 400 is set, at step 1104, the user terminal 100 determines whether or not the touch pressure at the touch starting point 400 is not less than a predetermined pressure. When the touch pressure at the touch starting point 400 is not less than the predetermined pressure, the user terminal proceeds to step 1106 and sets a touch-move determination region 410 with reference to the touch starting point. At this time, as illustrated in FIG. 4, the touch-move determination region 410 can be set as a region predetermined with reference to the touch starting point. The touch-move determination region 410 can include a central region 402 which is a region of a size predetermined with reference to the touch starting point 400 and a plurality of reference regions 404-1 to 404-4 according to directions predetermined with reference to the touch starting point 400.

After setting the touch-move determination region 410, the user terminal 100 conducts steps 1108 to 1128. Here, since the operations at steps 1108 to 1128 are substantially equal to those at steps 508 to 526 in FIG. 5, the descriptions corresponding to the steps 508 to 526 are referred to herein for steps 1108 to 1128.

Descriptions have been made on a case where the screen image 200 is moved and displayed according to the user's touch-move by setting the touch-move determination region 400 when the touch pressure at the touch starting point is not less than the predetermined pressure. However, according to the third embodiment, the screen image 200 can be moved and displayed according to the touch-move without setting the touch-move determination region 400 when the touch pressure at the touch starting point is not less than the predetermined pressure.

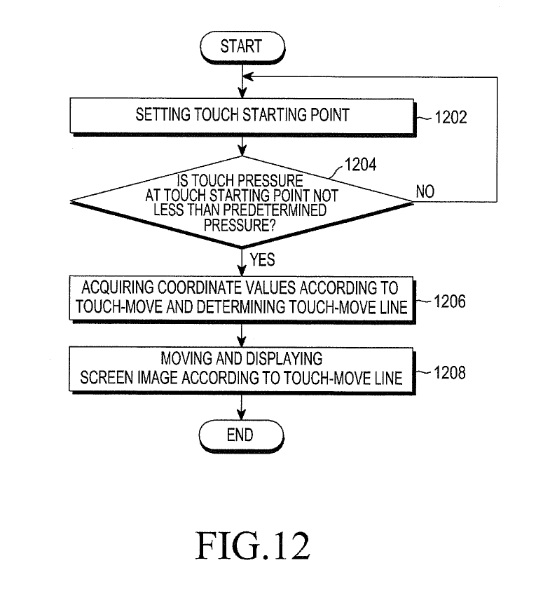

FIG. 12 is a flowchart illustrating a method of moving and displaying a screen image on the user terminal according to the third embodiment of the present disclosure. Referring to FIG. 12, at step 1202, the user terminal 100 sets a touch starting point 400. When a user's finger or a touch input object such as a stylus pen touches on touch screen 190, the user terminal 100 can set the touch-on point as the touch starting point 400. At this time, when touch-off occurs or touch is stopped, the touch starting point 400 can be set again.

When the touch starting point 400 is set, at step 1204, the user terminal 100 determines whether or not the touch pressure at the touch starting point 400 is not less than a predetermined pressure. When the touch pressure at the touch starting point 400 is not less than the predetermined pressure, the user terminal 100 proceeds to step 1206 and obtains coordinate values according to the touch-move to determine the touch-move line. In addition, at step 1210, the user terminal moves and displays the screen image 200 according to the touch-move line.

According to the above described exemplary embodiments of the present disclosure, it is possible to move a screen in a direction desired by the user on the user terminal 100 more conveniently. In addition, according to the present disclosure, a movement in a direction between the horizontal and vertical directions including the vertical and horizontal movements and the diagonal movement of the screen image 200 can be conveniently and efficiently conducted.

Herein below, a method of setting a touch starting point 400 according to an exemplary embodiment of the present disclosure will be described in more detail. According to an exemplary embodiment of the present disclosure, the user terminal 100 sets coordinates of the initial touch-on position as a touch starting point 400 and when the touch-move is interrupted during the touch-move, the user terminal 100 sets the new touch-on position as a new touch starting point 400. According to another exemplary embodiment, the user terminal 100 can set the coordinates of the initial touch-on position as the touch starting point 400 and when the touch-move is interrupted during the touch-move, the user terminal 100 can set the coordinates of the interrupted position as a new touch starting point 400.

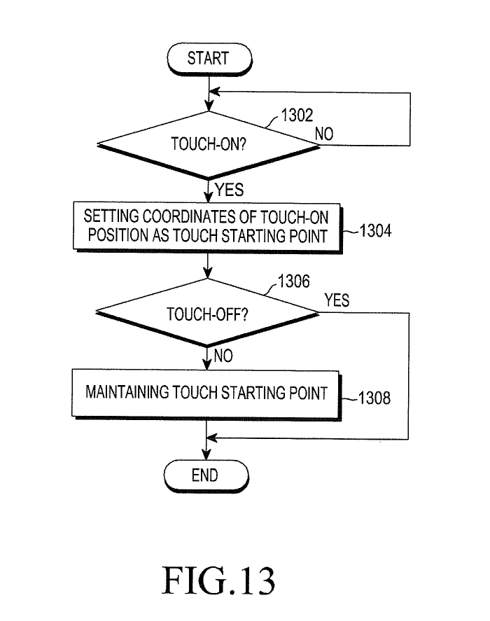

FIG. 13 is a flowchart illustrating a method of setting the touch starting point according to the first exemplary embodiment of the present disclosure. Referring to FIG. 13, at step 1302, the user terminal 100 determines whether or not the user's finger or a touch input object such as a stylus pen touches on the touch screen 190. When the touch input object touches on the touch screen, at step 1304, the user terminal 100 sets the coordinates of the touch-on position as the touch starting point 400.

At step 1306, the user terminal 100 determines whether or not the finger or the stylus pen touches off the touch screen 190. When the finger or the stylus pen touches off the screen 190, the user terminal 100 ends the subsequent steps and when the finger or the stylus pen newly touches on the touch screen 190, the user terminal 100 sets the coordinates of the newly touched position as the touch starting point 400.

When the finger or the stylus pen does not touch off the touch screen 190, at step 1308, the user terminal 100 maintains the touch starting point. At this time, the user terminal 100 can maintain the touch starting point even if the touch-move occurs in the state where the finger or the stylus pen does not touch off the touch screen 190, and conduct a corresponding function according to the touch-move.

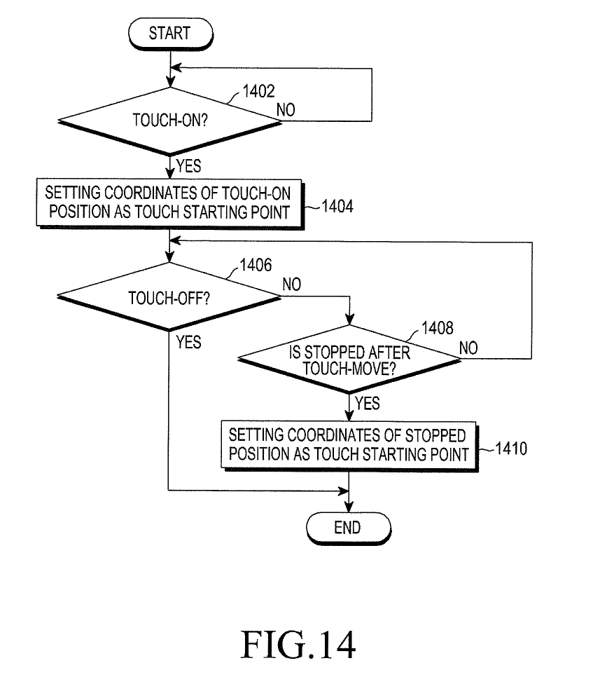

FIG. 14 is a flowchart illustrating a method of setting a touch starting point according to the second exemplary embodiment of the present disclosure. Referring to FIG. 14, at step 1402, the user terminal 100 determines whether or not the user's finger or a touch input object such as a stylus pen touches on the touch screen 190. When the touch input object touches on the touch screen 190, the user terminal 100 sets the coordinates of the touch-on position as the touch starting point 400 at step 1404.

At step 1406, the user terminal 100 determines whether or not the finger or the stylus pen touches off the touch screen 190. When the finger or the stylus pen touches off the touch screen 190, the user terminal 100 can terminate its operation and, when the finger or the stylus newly touches on the touch screen, the user terminal 100 can set the coordinates of the new touch-on position as the touch starting point 400.

When the finger or the stylus pen does not touch off the touch screen 190, at step 1408, the user terminal 100 determines whether the finger or the stylus pen is in a stopped state after the touch-move. When the finger or the stylus pen is in the stopped state after the touch-move, at step 1410, the user terminal 100 sets the coordinates of the stopped position after the touch-move as the touch starting point.

The touch starting point 400 setting method as described above can be selectively used according to the type of the screen image 400, for example, an application screen, a photo screen, and a web browser screen or by the user's selection.

According to the above described embodiments of the present disclosure, it is possible to move a screen image in the user terminal more conveniently in a direction desired by the user. In addition, according the above described exemplary embodiments, the movement of a screen image in a direction between vertical and horizontal directions, including vertical and horizontal movements and a diagonal movement may be more conveniently and efficiently conducted.

The methods according to the exemplary embodiments of the present disclosure may be implemented in a form of program commands executed through various computer means and stored in a computer-readable medium. The computer-readable medium may include, for example, program commands, data files and data structures individually or in combination. The program commands stored in the medium may be those specially designed and configured for the present disclosure or those well-known to be used by a person skilled in a computer software field.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user terminal comprising:
a touch screen configured to receive a touch gesture input and display a screen image; and
a control unit configured to
set a touch-move determination region with reference to a touch starting point according to the touch gesture input, and
when a touch-move line of the touch gesture input passes a predetermined reference region in a predetermined direction in the touch-move determination region, to move and display the screen image in the predetermined direction on the touch screen.

2. The user terminal of claim 1, wherein the touch-move determination region includes:
a central region of a size predetermined with reference to the touch starting point, and
a plurality of reference regions corresponding to a plurality of directions predetermined with reference to the touch starting point, respectively, and
each of the plurality of predetermined directions is a direction between a vertical direction and a horizontal direction.

3. The user terminal of claim 1, wherein, when a touch-on by a user occurs on the touch screen, the control unit is configured to set the coordinates of the touch-on position as a touch starting point.

4. The user terminal of claim 3, wherein, when touch-move occurs in the state of touch-on, the control unit is configured to determine whether or not the touch-move is interrupted.

5. The user terminal of claim 4, wherein, when the touch-move is interrupted, the control unit is configured to determine whether or not touch-on by the user occurs on the touch screen.

6. The user terminal of claim 4, wherein, when the touch-move is interrupted, the control unit is configured to set the coordinates of the touch-move interrupted position as a touch starting point.

7. The user terminal of claim 1, wherein, when the touch pressure at the touch starting point is not less than a predetermined pressure, the control unit is configured to set the touch-move determination region with reference to the touch starting point.

8. The user terminal of claim 1, wherein the touch screen receives a touch gesture input using a user's finger or a touch input object.

9. The user terminal of claim 1, wherein the screen image includes at least one of an application screen, a web browser screen, a photo screen, and a moving image screen.

10. A method of displaying a screen on a user terminal, comprising:
setting a touch starting point according to a touch gesture input;
setting a touch-move determination region with reference to the touch starting point;
determining whether or not a touch-move line of the touch gesture input passes a predetermined reference region in a predetermined direction in the touch-move determination region; and
moving and displaying the screen image in the predetermined direction when the touch-move line of the touch gesture input passes the predetermined reference region in a predetermined direction.

11. The method of claim 10, wherein the touch-move determination region includes:
a central region of a size predetermined with reference to the touch starting point, and
a plurality of reference regions corresponding to a plurality of directions predetermined with reference to the touch starting point, respectively, and
each of the plurality of predetermined directions is a direction between a vertical direction and a horizontal direction.

12. The method of claim 10, wherein setting the touch starting point includes:
when a touch-on by a user occurs on the touch screen, setting the coordinates of the touch-on position as a touch starting point.

13. The method of claim 11, wherein setting the touch starting point further includes:
when touch-move occurs in the state of touch-on, determining whether or not the touch-move is interrupted.

14. The method of claim 13, wherein setting the touch starting point further includes:
when the touch-move is interrupted, determining whether or not touch-on by the user occurs on the touch screen.

15. The method of claim 13, wherein setting the touch starting point further includes:
when the touch-move is interrupted, setting the coordinates of the touch-move interrupted position as a touch starting point.

16. The method of claim 10, wherein setting the touch-move determination region includes:
determining whether or not the touch pressure at the touch starting point is not less than a predetermined pressure.

17. The method of claim 10, wherein setting the touch-move determination region includes:
when the touch pressure at the touch starting point is not less than the predetermined pressure, setting the touch-move determination region with reference to the touch starting point.

18. The method of claim 11, wherein the screen image includes at least one of an application screen, a web browser screen, a photo screen, and a moving image screen.
